(19) United States
(12) Patent Application Publication
(10) Pub. No.: US 2026/0148734 A1
(43) Pub. Date: May 28, 2026

(54) HANDS-FREE COMMUNICATION SYSTEMS AND METHODS FOR AN AIRCRAFT

(71) Applicant: The Boeing Company, Arlington, VA (US)

(72) Inventors: Piyush Varshney, Bengaluru (IN); Kiran Gopala Krishna, Bengaluru (IN); Brian David Gilbert, Kenmore, WA (US)

(73) Assignee: The Boeing Company, Arlington, VA (US)

(21) Appl. No.: 18/959,395

(22) Filed: Nov. 25, 2024

(51) Int. Cl. G10L 13/04; H04L 1/00

(52) U.S. Cl. CPC G10L 13/04; H04L 1/0016

(57) ABSTRACT

A system and a method include detecting signals from the operator that are motion signals and/or audio signals. A coded datalink message is created by a first control unit by converting the signals to coded signals. Each of the signals is associated with a coded signal based on a reference table. The coded datalink message is communicated with a second control unit. The second control unit decodes the coded datalink message by converting the coded signals to the signals based on the reference table and executes the datalink message.

### FIELD OF THE DISCLOSURE

Examples of the present disclosure generally relate to hands-free communication systems and methods, such as used by an operator of an aircraft.

### BACKGROUND OF THE DISCLOSURE

Aircrew workloads increase when faced with one or more unpredictable situations, such as meteorological conditions, high traffic density, system warnings or alerts, during take-off and/or climb operations, during approach and/or landing operations, etc. A pilot may need to interact with a control system or display unit onboard the aircraft during operation of the aircraft, but doing so during the turbulence or the unpredictable situations may lead to typing mistakes. For example, existing methods require a pilot to manually interact with cockpit systems via push buttons, knob dials, keyboards, touchscreens, etc. Executing a specific action requires a series of button presses and may result in the pilot entering a wrong value, pressing a wrong alpha-numeric key, etc. Furthermore, the manual interactions with the cockpit systems increase pilot head-down time, increases the chance for wrong entry, especially during turbulence, increases an amount of time to reach a specific page of a display unit due to multiple button presses, etc. As one example, the pilot may request an altitude target from an air-traffic controller, which may instruct the pilot to descend to 22,500 ft. However, during a turbulent situation, the pilot may incorrectly enter the altitude value as 22,250ft.

In certain instances, the pilot may request assistance, such as from the air-traffic controller or an airline operations center, during these conditions. For example, the air-traffic controller may send updates to the pilot as data uplinks which the pilot receives, reviews, and accepts or rejects. However, this too requires the pilot to first communicate to the ground station by sending an initial message or an audio message to the ground station. In order to send the initial message, the pilot must again manually navigate one or more screens of the display unit to access a specific page in order to press a button on the specific page. Moreover, a language barrier may be present between the pilot and the operator at the air-traffic controller during radio communication, thereby leading to misunderstanding, mishearing, etc.

Certain aircrafts may include some onboard monitoring systems that allow pilots to interact with certain systems via voice and/or gesture. However, other onboard avionics systems, such as a flight management system, may be incapable of receiving and/or comprehending such interactions. Moreover, these avionic systems may be regulated such that any changes made to the systems may require re-certification after any such change is made, which is costly and time consuming.

### SUMMARY OF THE DISCLOSURE

A need exists for a communication system and method that allows a pilot to communicate with onboard avionic systems and/or with off-board control systems in a hands-free or substantially hands-free manner. Further, a need exists for a system that allows a pilot to enter and/or change data associated with an onboard avionics system while bypassing keyboard and/or touchscreen interactions, thereby controlling an amount of “head down” time of the pilot. Further, a need exists for a system that enables voice interactions with an operator that can be expanded and/or modified without modifying certified software of the onboard avionics system.

With those needs in mind, certain examples of the present disclosure provide a method for communicating between two or more control units. The method includes detecting signals from the operator that may be motion signals and/or audio signals. A coded datalink message is created by a first control unit by converting the signals to coded signals. Each of the signals is associated with a coded signal based on a reference table. The coded datalink message is communicated with a second control unit. The second control unit decodes the coded datalink message by converting the coded signals to the signals based on the reference table and executes the datalink message.

In at least one example, the first control unit can be disposed onboard an aircraft and the second control unit can be disposed onboard the aircraft. In another example, the first control unit can be disposed off-board an aircraft and the second control unit can be disposed onboard the aircraft. In at least one example, communicating the coded datalink message may include relaying the coded datalink message via an onboard relaying system (e.g., an electronic flight bag or other wireless transceiving system) and/or an off-board relaying system (e.g., a satellite, a cloud-based data system, etc.).

In at least one example, the second control unit may execute the datalink message by changing some data that is stored within a memory of the second control unit. Optionally, the data that is changed may be displayed via a display device responsive to changing the data stored in the memory. In at least one example, an audio file associated with the data that is changed may be created, and may be played to the operator via an audio system of the aircraft.

In at least one example, a response message from the second control unit may be received at the first control unit responsive to the second control unit executing the datalink message. The response message may be displayed to the operator via a display device or an audio file of the response may be plated to the operator via an audio system of the aircraft.

In at least one example, the signals from the operator may be detected and the first control unit may create the coded datalink message while the aircraft is on ground and/or while the aircraft is in flight.

Certain examples of the present disclosure provide a hands-free communication system that includes one or more sensors that may be configured to detect one or more signals from an operator. The one or more signals that are detected are one or more of motion signals or audio signals. A first control unit may create a coded datalink message by converting the one or more signals to one or more coded signals with a first control unit. Each of the one or more signals is associated with a corresponding coded signal based on a reference table. A second control unit may receive the coded datalink message from the first control unit, may decode the coded datalink message by converting the one or more coded signals to the one or more signals based on the reference table, and execute the datalink message.

Certain examples of the present disclosure provide a non-transitory computer-readable storage medium comprising executable instructions that, in response to execution, cause one or more control units comprising one or more processors to perform operations that include detecting one or more signals from an operator. The one or more signals that are detected are one or more of motion signals or audio signals. A coded datalink message is created by converting the one or more signals to one or more coded signals with a first control unit. Each of the one or more signals is associated with a corresponding coded signal based on a reference table. The coded datalink message is communicated with a second control unit. The second control unit decodes the coded datalink message by converting the one or more coded signals to the one or more signals based on the reference table. The datalink message is executed by the second control unit by changing at least some data stored within a memory of the second control unit. At least some of the data that is changed may be displayed via a display device responsive to changing at least some of the data stored within the memory of the second control unit.

### BRIEF DESCRIPTION OF THE DRAWINGS

FIG. 1 illustrates a schematic block diagram of a system for communicating between an aircraft and a ground controlling system, according to an example of the present disclosure.

FIG. 2 illustrates a schematic block diagram of a control unit of an aircraft, according to an example of the present disclosure.

FIG. 3 illustrates a schematic block diagram of an electronic flight bag of an aircraft, according to an example of the present disclosure.

FIG. 4 illustrates a communication management system of an aircraft, according to an example of the present disclosure.

FIG. 5 illustrates an off-board control unit of a ground controlling system, according to an example of the present disclosure.

FIG. 6 illustrates a flow chart of a method for hands-free communication, according to an example of the present disclosure.

FIG. 7 illustrates examples of motion and audio signals, according to an example of the present disclosure.

FIG. 8 illustrates an example of a reference table, according to an example of the present disclosure.

FIG. 9 illustrates a perspective front view of an aircraft, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

Pilots need to interact with onboard avionics systems during flight and/or while the aircraft is on ground. The pilots of the aircraft need to be able to communicate with the onboard systems and with off-board systems, such as air-traffic controllers, airline operations centers, maintainer workstations, etc. The systems and methods described herein provide a hands-free or substantially hands-free communication system for communicating between two or more different control units onboard and/or off-board the aircraft. The hands-free communication system can allow the pilot to communicate with onboard avionics systems, such as a flight management system, via another onboard system, such as an electronic flight bag.

The systems and methods provide an encoding system that can be operated or run on a ground machine, an electronic flight bag, a communication management system, or other system or device that is able to send controller pilot data link communication (CPDLC) messages to an avionics system, such as a flight management system. The encoding system may include speech recognition software, gesture recognition engines, or the like, that allow the pilot to communicate a CPDLC message via audio signals and/or motion signals. The avionics system may include a decoding system that is capable of receiving the encoded CPDLC messages and decoding the CPDLC message.

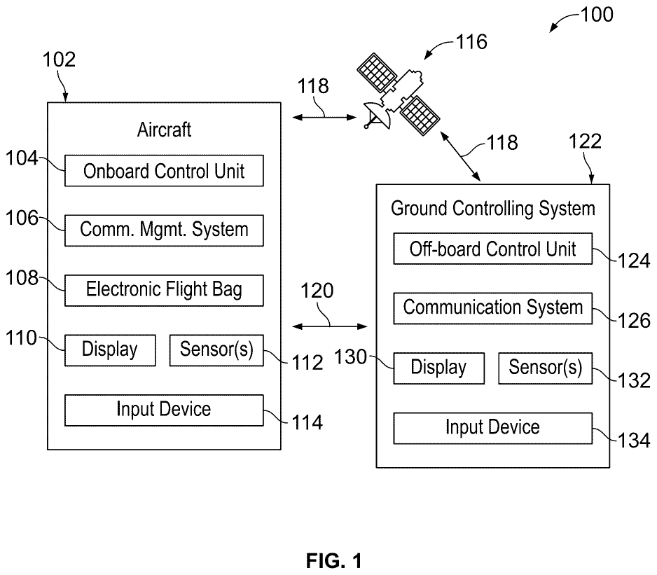

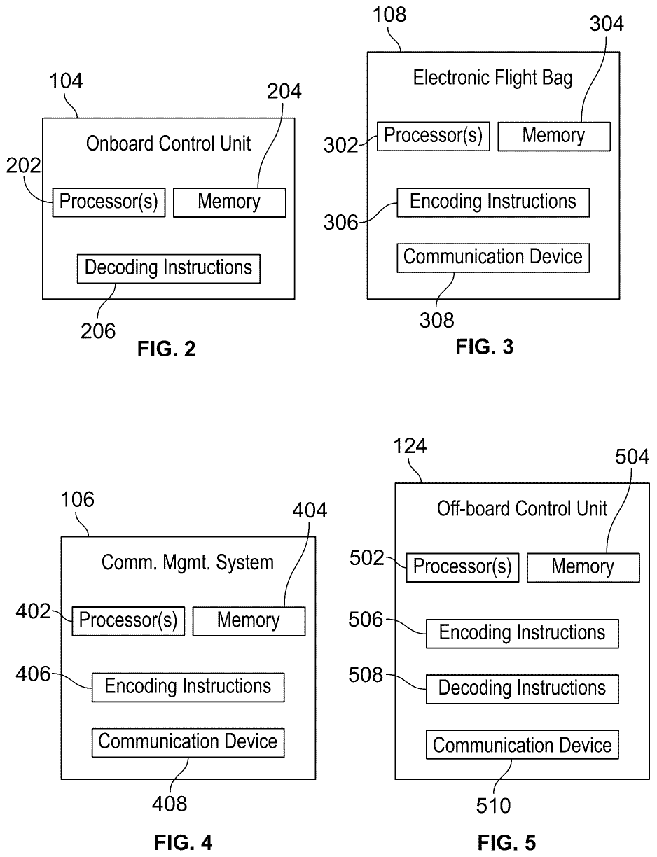

FIG. 1 illustrates a schematic block diagram of a system 100, according to an example of the present disclosure. The system 100 includes an aircraft 102 and a ground controlling system 122. The aircraft 102 includes an onboard control unit 104 having one or more processors. The onboard control unit 104 may control one or more components, systems, and/or operations of the aircraft. The onboard control unit 104 of the aircraft 102 may be in communication with a communication management system 106 and electronic flight bag 108 of the aircraft 102 such as through one or more wired or wireless connections. For example, the communication management system 106 may can include and/or represent one or more antennas, transceivers, radios, and/or the like, that enable wired and/or wireless communication between the systems onboard the aircraft, between the aircraft and systems off-board the aircraft, or the like. The onboard control unit 104, the communication management system 106, and the electronic flight bag 108 will be further discussed with reference to FIGS. 2-4.

The aircraft 102 includes a user interface, such as within an internal cabin of the aircraft, that can include a display 110 and an input device 114. For example, the display 110 may be an electronic monitor, a television, a touch screen, and/or the like, and the input device 114 may be and/or include a keyboard, a headset, a microphone, a mouse, a stylus, and/or the like. In at least one example, the display 110 and the input device 114 may be integrated as a touchscreen interface. In at least one example, the display 110 and input device 114 may be included and/or associated with a computer workstation, a handheld device (e.g., a smartphone, smart tablet, or the like), or the like.

The aircraft 102 includes one or more sensors 112 that may sense and/or detect information, such as from an operator onboard the aircraft. For example, the sensors 112 can include and/or represent one or more motion sensors, thermal sensors, vibrational sensors, cameras (e.g., a camera that obtains still images and/or video), or the like. In at least one example, one or more sensors 112 may sense and/or detect information associated with the aircraft 102. For example, the sensors may include and/or represent a global positioning system sensor, a radar sensor, or the like.

The ground controlling system 122 includes an off-board control unit 124 having one or more processors. In one example, the ground controlling system 122 may represent an air-traffic controller, an airline operations center, a workstation, a maintenance workstation, or the like. The off-board control unit 124 may control one or more components, systems, and/or operations of the ground controlling system 122. The ground controlling system 122 includes a communication system 126 that can include and/or represent one or more antennas, transceivers, radios, and/or the like, that enable wired and/or wireless communication between the components and/or systems of the ground controlling system 122, between the ground controlling system 122 and the aircraft 102, between the ground controlling system 122 and another system (not shown), or the like.

In one example, the ground controlling system 122 may include a user interface that can include a display 130 and an input device 134. The display 130 may be an electronic monitor, a television, a touch screen, and/or the like, and the input device 134 may be and/or include a keyboard, a headset, a microphone, a mouse, a stylus, and/or the like. In at least one example, the display 130 and the input device 134 may be integrated as a touchscreen interface. In at least one example, the display 130 and input device 134 may be included and/or associated with a computer workstation, a handheld device (e.g., a smartphone, smart tablet, or the like), or the like.

The aircraft 102 is in communication with the ground controlling system 122. For example, one or more communication messages may originate at the aircraft 102, such as by the operator or pilot, and may be communicated to the ground controlling system 122. Additionally or alternatively, messages may originate at the ground controlling system 122, such as by an air-traffic control operator, a maintenance worker, a remote pilot, or the like, and may be communicated to the aircraft 102. In at least one example, the aircraft 102 and the ground controlling system 122 may be communicatively coupled through an off-board relaying system 116 that can represent a satellite, a cloud-based data system, or the like. The off-board relaying system 116 may enable bi-directional communication link 118 between the aircraft 102 and the ground controlling system 122. In at least one example, the off-board relaying system 116 may enable bi-directional communication between the aircraft 102 and another aircraft system (not shown), such as an airplane, an unmanned aircraft system, or the like.

In another example, the aircraft 102 may be communicatively coupled with the ground controlling system 122 (or another off-board system, not shown) via a sidelink communication link 120. In at least one example, the electronic flight bag 108 may enable and/or provide the wireless communication pathway between the aircraft 102 and the ground controlling system 122.

FIG. 2 illustrates a schematic block diagram of the onboard control unit 104, according to an example of the present disclosure. In one or more examples, the onboard control unit 104 may represent a flight management system and/or flight management computer that is onboard the aircraft. The onboard control unit 104 includes one or more processors 202, a memory 204 that can store decoding instructions 206, data (e.g., generated data and/or received data), or the like.

FIG. 3 illustrates a schematic block diagram of the electronic flight bag 108 according to an example of the present disclosure. In one example, the electronic flight bag 108 may represent a portable processing device and/or system that may be transferably moved onto the aircraft 102. In one example, the electronic flight bag 108 may include one or more processors 302, a memory 304 that can store encoding instructions 306 and any alternative data (e.g., generated data and/or received data), and a communication device 308 that may allow communication between the electronic flight bag 108 and one or more systems onboard and/or off-board the aircraft 102.

FIG. 4 illustrates a schematic block diagram of the communication management system 106 according to an example of the present disclosure. In one example, the communication management system 106 may include one or more processors 402, a memory 404 that can store encoding instructions 406 and any alternative data (e.g., generated data and/or received data), and a communication device 408 that may allow communication between the communication management system 106 and one or more systems onboard and/or off-board the aircraft 102.

FIG. 5 illustrates a schematic block diagram of the off-board control unit 124 of the ground controlling system 122 according to an example of the present disclosure. In one example, the off-board control unit 124 may include one or more processors 502, a memory 504 that can store encoding instructions 506, decoding instructions 508, and/or alternative data (e.g., generated data and/or received data), and a communication device 510 that may allow communication between the off-board control unit 124 and one or more systems onboard and/or off-board the aircraft 102.

FIGS. 3 through 5 are merely exemplary and are non-limiting. In one example, two or more systems may share a common memory, a common communication device and/or common transceiving hardware and/or software, common processor(s), common coding and/or decoding instructions, or any combination therein.

In one or more examples, an operator of the aircraft 102 and/or an operator of the ground controlling system 122 may create and/or generate a message to be communicated with a hands-free communication system. For example, the pilot of the aircraft 102 may need to communicate a message to the air traffic controller and may generate the message without the pilot touching or otherwise physically engaging one or more buttons, screens, knobs, or any alternative engagement device of the aircraft 102. Similarly, the operator of the ground controlling system, such as a remote pilot or a ground staff, may need to communicate a message to the pilot onboard the aircraft 102 and may generate the message without the remote pilot or ground staff touching or otherwise physically engaging one or more buttons, screens, knobs, or any alternative physical engagement device of the ground controlling system 122.

In order to generate and communicate a hands-free message between two or more systems onboard the aircraft 102, between a system onboard the aircraft 102 and a control unit of the ground controlling system 122, or the like, one or more control units of the aircraft and/or the ground controlling system 122 may include encoding and/or decoding software instructions. For example, one or more control units of the aircraft 102 and/or the ground controlling system 122 may include encoding software instructions that may allow the control unit to receive signals from an operator (e.g., audio signals, motion signals, or the like) and convert the signals into coded signals. In at least one example, the signals from the operator may be associated with a message, instructions, a request, or the like. The coded signals may be communicated with another control unit (e.g., another control unit onboard the aircraft 102, a control unit off-board the aircraft 102, or the like). The receiving or second control unit may include decoding software instructions that allow the second control unit to convert the coded signals to the original, decoded signals, and execute the message generated by the operator.

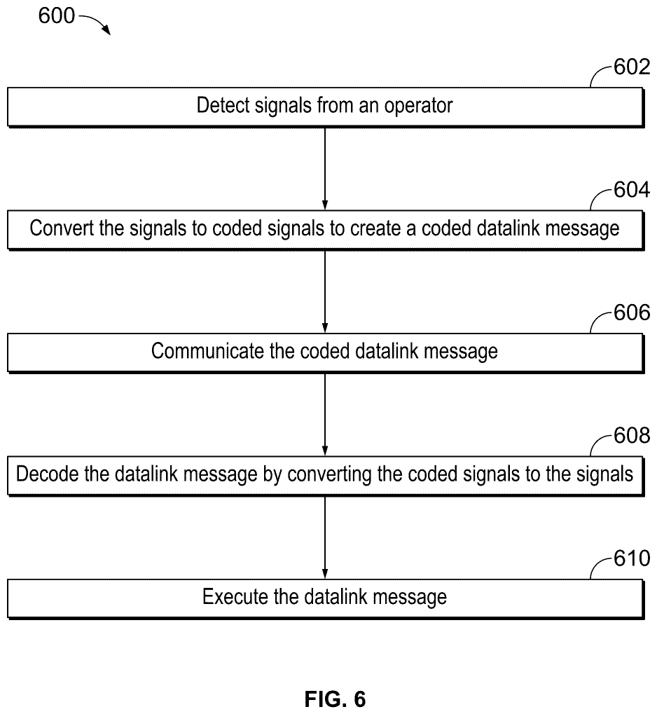

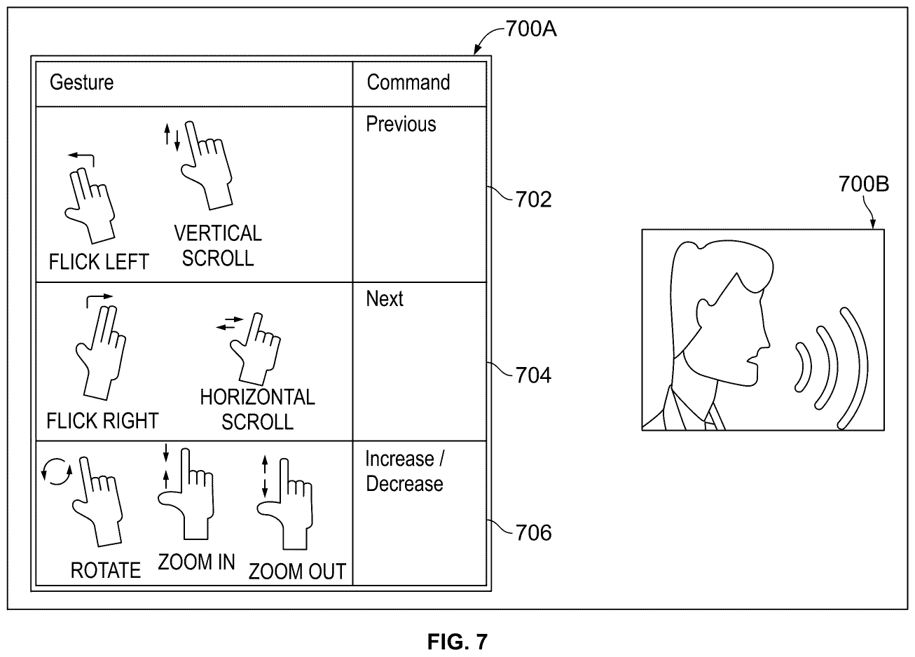

FIG. 6 illustrates a flow chart 600 of a method for hands-free communication, according to an example of the present disclosure. At 602, one or more signals from an operator may be detected. The signals may be hand signals, audio signals, or the like. In one example, the operator may be a pilot onboard the aircraft 102, and one or more sensors 112 may detect or otherwise sense the signals from the pilot. The signals from the pilot may be associated with a message that the pilot is trying to and/or intends to communicate.

FIG. 7 illustrates examples of motion and audio signals, according to an example of the present disclosure. For example, a first group of signals 700A may include plural motion signals. As one example, the first group of signals 700A may allow the pilot to control and/or change a display setting of the display 110 onboard the aircraft. First motion signals 702 may allow the pilot to go to a previous display screen of the display 110, second motion signals 704 may allow the pilot to go to a next display screen of the display 110, and third motion signals 706 may allow the pilot to change an orientation and/or magnification of the display 110. The sensors may detect the motions of the pilot and the processors 202 of the onboard control unit 104 may change a display setting of the display 110 responsive to the detection of the motion signals.

In another example, the signals from the pilot may be audio signals 700B. For example, the sensors may include and/or represent a microphone, an audio panel, a pilot headset, an audio channel, or the like, that may detect the audio signals generated by the pilot. In one or more examples, the audio system may be associated with a push-to-talk switch that the pilot must first engage before communicating the audio signals.

Returning to FIG. 6, the sensors may detect the signals from the operator and may transmit the signals and/or the data associated with the signals to a first control unit. In one example, the first control unit may represent the electronic flight bag 108, the communication management system 106, or an alternative system onboard the aircraft 102. In another example, the datalink message may originate from an operator of the ground controlling system 122 and the first control unit may represent the off-board control unit 124. In one or more examples, the first control unit may include a speech recognition software and/or instructions associated with detecting, recognizing, understanding, or the like, speech or any alternative audio signals, may include gesture recognition engines that may detect and recognize gestures or motions made by the pilot, may include a camera to capture images and/or video of the pilot signals, may include natural language processing software, or the like.

At 604, the first control unit creates a coded datalink message by converting the signals from the operator to one or more coded signals. Each of the one or more signals may be associated with a corresponding coded signal based on a reference table.

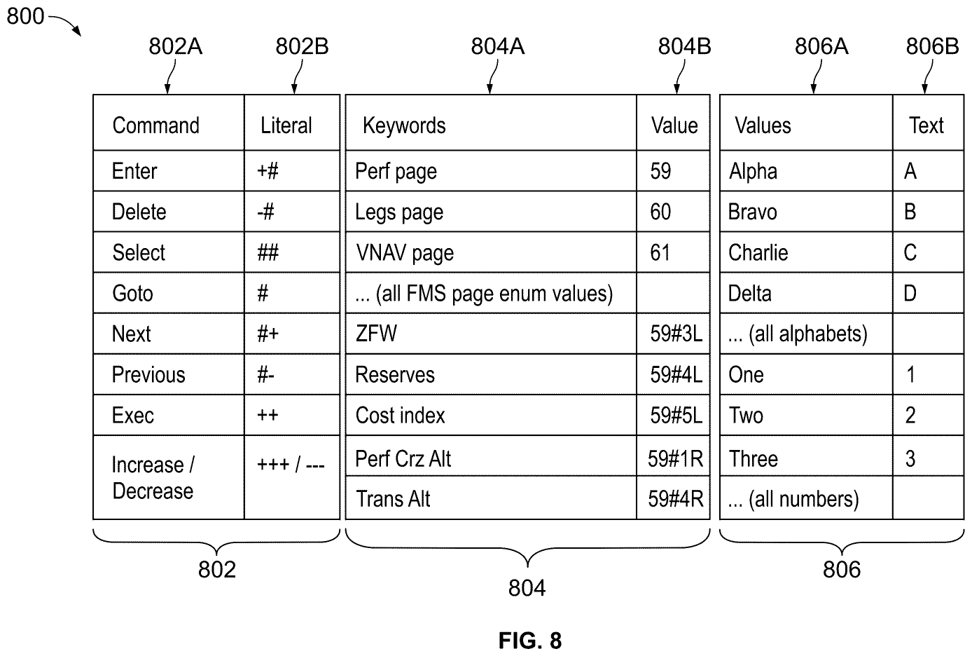

FIG. 8 illustrates an example of a reference table 800, according to an example of the present disclosure. The reference table 800 may be stored in the memory 304 of the electronic flight bag 108, in the memory 404 of the communication management system 106, in the memory 504 of the off-board control unit 124, or the like. In one or more examples, the reference table 800 may be associated with and/or included in the encoding instructions 306, 406, 506, respectively, of the different control units.

In one example, the reference table 800 may include a first set of data 802 having a first set of signals 802A and a corresponding first set of coded signals 802B; a second set of data 804 having a second set of signals 804A and a corresponding second set of coded signals 804; and a third set of data 806 having a third set of signals 806A and a corresponding third set of coded signals 806B. The reference table 800 shown in FIG. 8 is merely exemplary, and non-limiting.

In one example, the pilot may need to change or update information associated with the onboard control unit 104 (e.g., a flight management system of the aircraft) and may want to update the information without touching or physically engaging with the display 110 and/or input device 114 of the aircraft 102. The pilot may audibly say the statement or phrase “FMS Enter ZFW one zero zero.” For example, the statement or phrase audibly communicated by the pilot may be the datalink message intended to be communicated with the onboard control unit 104 (e.g., the flight management system (FMS)), and that the FMS should enter and/or change the zero-fuel weight value stored in the FMS to “100.” As another example, the pilot may need to communicate a datalink message with an airline operations center, an air-traffic controller, a maintenance workstation, or the like.

The processors 302 of the electronic flight bag 108 (e.g., representative of the first control unit) may receive the audio signals from the sensors and may convert the audio signals into coded signals using the encoding instructions 306 based on the reference table 800 to create a coded datalink message. The signals “FMS Enter ZFW one zero zero” from the pilot may be converted into corresponding coded signals to create the coded datalink message “FMS+#59#3L100” based on the first, second, and third sets of data 802, 804, 806, respectively, of the reference table 800.

In one example, the pilot may communicate (e.g., via audio, motion, or the like) the signals associated with the datalink message, the sensors may detect or otherwise sense the signals, and the first control unit (e.g., of the electronic flight bag, the communication management system, or the like) may create the coded datalink message while the aircraft 102 is in flight (e.g., cruising, descending, ascending, or the like) and/or while the aircraft 102 is on ground (e.g., on ground and stationary, on ground and taxiing, or the like). For example, the pilot may be able to generate and communicate the datalink message, and the datalink message may be converted into the coded datalink message, independent of a location of the aircraft 102.

In another example, two or more coded datalink messages may be created based on a single set and/or group of signals by the pilot. For example, the pilot may audibly say “FMS enter ZFW one zero zero and set flaps to 10” as a single line of audio communication. The processors 302 of the electronic flight bag 108 may receive the single set of audio signals and may convert the single set of audio signals into two separate and distinct coded datalink messages.

Returning to FIG. 6, at 606, the one or more coded datalink messages may be communicated with another control unit. For example, the datalink message in the example indicates that the receiving control unit (e.g., a second control unit) is the onboard control unit 104 (e.g., the flight management system). In an alternative example, the receiving control unit may be another control unit onboard the aircraft 102, may be the off-board control unit 124 of the ground controlling system 122, may be another control unit disposed off-board the aircraft 102, or the like. Optionally, the datalink message may originate by an operator of the ground controlling system 122 and the off-board control unit 124 may represent the first control unit, and the coded datalink message may need to be communicated with a control unit onboard the aircraft 102.

In one example, the one or more coded datalink messages may be communicated between the aircraft 102 and the ground controlling system 122 via the bi-directional communication link 118 utilizing the off-board relaying system 116. As another example, the coded datalink message may be communicated between the systems onboard the aircraft 102 and the pilot via the sidelink communication link 120 utilizing an onboard relaying system. For example, the onboard relaying system may be and/or represent the electronic flight bag 108, the communication management system 106, or the like.

At 608, the second control unit may decode the one or more coded datalink messages by converting the coded signals to the original signals based on the reference table 800. For example, the processors 202 of the onboard control unit 104 (e.g., the flight management system) may receive the coded datalink message from the electronic flight bag 108 and may decode the coded signals into the original signals using the decoding instructions 206 based on the reference table 800 to create a coded datalink message. For example, the memory 204 of the onboard control unit 104 may store and/or have access to the reference table 800. The processors 202 may receive the coded datalink message “FMS+#59#3L100” and may decode the message into the original message “FMS Enter ZFW one zero zero” communicated by the pilot.

In one or more examples, one or more processors and/or systems onboard and/or off-board the aircraft may be capable of encoding the one or more signals into a coded datalink message. Additionally, one or more processors and/or systems onboard the aircraft may be capable of decoding the coded datalink message. For example, the encoding software may be onboard and/or off-board the aircraft, but the decoding software may be only onboard the aircraft. For example, the encoding software may be available and/or installed in one or more systems that allow software updates, changes, etc., without requiring a recertification of the software system. Alternatively, the encoding software may not be allowed to be and/or available to be installed in one or more systems that require recertification of software subsequent to any software updates, changes, etc.

At 610, the second control unit executes the datalink message. As one example, the datalink message may provide directions, instructions, or the like, to the onboard control unit 104 to change at least some data that is stored in the memory 204 of the onboard control unit 104, such as to enter and/or change the zero-fuel weight value stored in the memory 204 of the flight management system to “100.” For example, the pilot may be able to enter or change the zero-fuel weight value in the onboard control unit 104 without physically engaging any buttons, knobs, screens, switches, or the like, in the aircraft 102. Additionally, the pilot may be able to enter or change the zero-fuel weight value, other data stored in the onboard control unit 104, communicate a message to an air-traffic controller, to a workstation, or the like, without looking at and/or physically engaging with any buttons, knobs, screens, switches, or the like, in the aircraft 102.

In one example, the display 110 of the aircraft 102 may display at least some of the data that is changed responsive to the second control unit executing the datalink message. For example, the display 110 may display the updated zero-fuel weight value being 100 responsive to the zero-fuel weight value being entered and/or changed.

In one example, the second control unit (e.g., the onboard control unit 104) may include and/or be in communication with a software system that converts text to speech. For example, the second control unit may create an audio file associated with at least some of the data that has been changed based on the execution of the datalink message. The second control unit may play or present the audio file (e.g., via a speaker of an audio system onboard the aircraft, via a speaker of a headset that is worn by the pilot, or the like) to the pilot via the audio system of the aircraft 102. As another example, the second control unit may represent the off-board control unit, and an audio system of the off-board control unit may play or present the audio file to an operator of the ground controlling system 122.

In one example, the first control unit may be represented by the processors 302 of the electronic flight bag 108 and the second control unit may be represented by the onboard control unit 104, which may receive the coded datalink messages, decode the datalink messages, and communicate the decoded datalink messages with the off-board control unit 124 of the ground controlling system 122. In one or more examples, the pilot may create a datalink message that is to be communicated to the air-traffic controller. The electronic flight bag 108 may change the signals from the pilot to coded signals, which may be decoded by the onboard control unit 104 and subsequently communicated to the off-board control unit. The off-board control unit may receive the decoded signals and may execute the datalink message. The off-board control unit 124, or an operator of the ground controlling system 122, may create a response message that is communicated to the pilot of the aircraft 102.

In one example, the display 110 of the aircraft 102 may display the response message to the pilot. In another example, one or more systems onboard the aircraft 102 may convert the response message to an audio file, and an audio system of the aircraft may audibly present the response message to the pilot. For example, the response message may be confirmation that the datalink message has been executed, may be a follow-up instruction from the ground controlling system 122, may be a response to a question from the pilot of the aircraft 102, or the like. In one example, the pilot may create additional signals, such as additional audio signals, in response to receiving the response message. The additional audio signals may be coded, communicated, and decoded thereby confirming to the operator of the ground controlling system 122 that the pilot has received the response message, to confirm that the pilot has understood the response message, or the like.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the onboard control unit 104, the off-board control unit 124, the electronic flight bag 108, the communication management system 106, or the like, may be or include one or more processors that are configured to control one or more operations, as described herein.

The control unit(s) are configured to execute a set of instructions that are stored in one or more data storage units or elements (such as the one or more memories 204, 304, 404, 504), in order to process data. The data storage units may also store data or other information as desired or needed. The data storage units may be in the form of an information source or a physical memory element within a processing machine.

The set of instructions may include various commands that instruct the control units as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of examples herein may illustrate one or more control or processing units, such as the onboard and off-board control units 104, 124. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the control units may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

Referring to FIGS. 1-9, examples of the subject disclosure provide systems and methods that allow large amounts of data to be quickly and efficiently analyzed by a computing device. For example, the onboard control unit 104, the off-board control unit 124, the processors of the communication management system 106, and/or the processors of the electronic flight bag 108 can analyze various aspects of aircraft 102, traffic, notifications, and the like. As such, large amounts of data, which may not be discernable by human beings, are being tracked and analyzed. The vast amounts of data are efficiently organized and/or analyzed by the control units, as described herein. The control units analyze the data in a relatively short time in order to quickly and efficiently code, decode, and execute datalink messages. A human being would be incapable of efficiently analyzing such vast amounts of data in such a short time. As such, examples of the present disclosure provide increased and efficient functionality, and vastly superior performance in relation to a human being analyzing the vast amounts of data.

In at least one example, all or part of the systems and methods described herein may be or otherwise include an artificial intelligence (AI) or machine-learning system that can automatically perform the operations of the methods also described herein. For example, one or more of the processors disposed off-board and/or onboard the aircraft can be an artificial intelligence or machine learning system. These types of systems may be trained from outside information and/or self-trained to repeatedly improve the accuracy with how data is analyzed. Over time, these systems can improve by determining such information with increasing accuracy and speed, thereby significantly reducing the likelihood of any potential errors. The AI or machine-learning systems described herein may include technologies enabled by adaptive predictive power and that exhibit at least some degree of autonomous learning to automate and/or enhance pattern detection (for example, recognizing irregularities or regularities in data), customization (for example, generating or modifying rules to optimize record matching), and/or the like. The systems may be trained and re-trained using feedback from one or more prior analyses of the data, ensemble data, and/or other such data. Based on this feedback, the systems may be trained by adjusting one or more parameters, weights, rules, criteria, or the like, used in the analysis of the same. This process can be performed using the data and ensemble data instead of training data, and may be repeated many times to repeatedly improve the communication between the pilot and systems onboard and off-board the aircraft. The training minimizes conflicts and interference by performing an iterative training algorithm, in which the systems are retrained with an updated set of data (for example, data received before, during, and/or after each flight of the aircraft 102) and based on the feedback examined prior to the most recent training of the systems. This provides a robust analysis model that can better determine situational information in a cost effective and efficient manner.

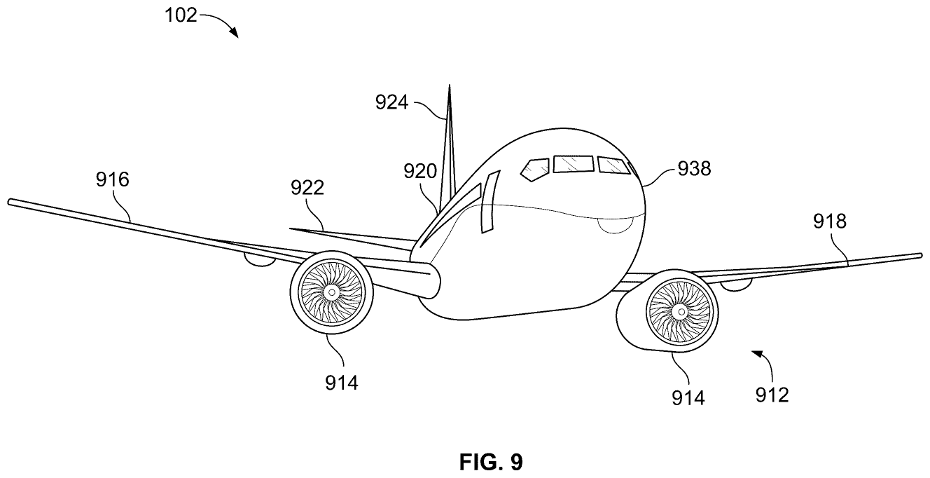

FIG. 9 illustrates a perspective front view of the aircraft 102, according to an example of the present disclosure. The aircraft 102 includes a propulsion system 912 that includes engines 914, for example. Optionally, the propulsion system 912 may include more engines 914 than shown. The engines 914 are carried by wings 916 of the aircraft 102. In other examples, the engines 914 may be carried by a fuselage 918 and/or an empennage 920. The empennage 920 may also support horizontal stabilizers 922 and a vertical stabilizer 924. The fuselage 918 of the aircraft 102 defines an internal cabin, which includes a flight deck or cockpit, one or more work sections (for example, galleys, personnel carry-on baggage areas, and the like), one or more passenger sections (for example, first class, business class, and coach sections), one or more lavatories, and/or the like. FIG. 9 shows an example of an aircraft 102. It is to be understood that the aircraft 102 can be sized, shaped, and configured differently than shown in FIG. 9.

Further, the disclosure comprises examples according to the following clauses:

Clause 1: a Method, Comprising:
detecting one or more signals from an operator, wherein the one or more signals that are detected are one or more of motion signals or audio signals;
creating a coded datalink message by converting the one or more signals to one or more coded signals with a first control unit, wherein each of the one or more signals is associated with a corresponding coded signal based on a reference table;
communicating the coded datalink message with a second control unit;
decoding the coded datalink message by converting the one or more coded signals to the one or more signals with the second control unit based on the reference table; and
executing the datalink message with the second control unit.

Clause 2: the method of clause 1, wherein the first control unit is disposed onboard an aircraft and the second control unit is disposed onboard the aircraft.

Clause 3: the method of clauses 1 or 2, wherein the first control unit is disposed off-board an aircraft and the second control unit is disposed onboard the aircraft.

Clause 4: the method of any of clauses 1-3, wherein communicating the coded datalink message includes relaying the coded datalink message via one or more of an onboard relaying system or an off-board relaying system.

Clause 5: the method of any of clauses 1-4, wherein executing the datalink message includes changing at least some data stored within a memory of the second control unit.

Clause 6: the method of clause 5, further comprising displaying at least some of the data that is changed via a display device responsive to changing at least some of the data stored within the memory of the second control unit.

Clause 7: the method of clause 5, further comprising:
creating an audio file associated with the at least some of the data that is changed with the second control unit; and
playing the audio file to the operator via an audio system.

Clause 8: the method of any of clauses 1-7, further comprising controlling a display setting of a display device based at least in part on the one or more signals that are detected.

Clause 9: the method of any of clauses 1-8, further comprising:
receiving a response message from the second control unit responsive to the execution of the datalink message by the second control unit; and
one or more of displaying the response message the operator via a display device or audibly playing an audio file of the response message to the operator via an audio system.

Clause 10: the method of any of clauses 1-9, further comprising detecting the one or more signals from the operator of an aircraft and creating the coded datalink message while the aircraft is one or more of on ground or in flight.

Clause 11: a hands-free communication system, comprising:
one or more sensors configured to detect one or more signals from an operator, wherein the one or more signals that are detected are one or more of motion signals or audio signals;
a first control unit configured to create a coded datalink message by converting the one or more signals to one or more coded signals, wherein each of the one or more signals is associated with a corresponding coded signal based on a reference table; and
a second control unit configured to receive the coded datalink message from the first control unit, wherein the second control unit is configured to decode the coded datalink message by converting the one or more coded signals to the one or more signals with the second control unit based on the reference table,
wherein the second control unit is configured to execute the datalink message.

Clause 12: the hands-free communication system of clause 11, wherein the first control unit is disposed onboard an aircraft and the second control unit is disposed onboard the aircraft.

Clause 13: the hands-free communication system of clauses 11 or 12, wherein the first control unit is disposed off-board an aircraft and the second control unit is disposed onboard the aircraft.

Clause 14: the hands-free communication system of any of clauses 11-13, wherein the coded datalink message is configured to be communicated between the first control unit and the second control unit by relaying the coded datalink message via one or more of an onboard relaying system or an off-board relaying system.

Clause 15: the hands-free communication system of any of clauses 11-14, wherein the second control unit is configured to execute the datalink message by changing at least some data stored within a memory of the second control unit.

Clause 16: the hands-free communication system of clause 15, further comprising a display device configured to display at least some of the data that is changed.

Clause 17: the hands-free communication system of any of clauses 11-16, further comprising a display device, wherein the one or more signals that are detected are configured to change a display setting of the display device.

Clause 18: the hands-free communication system of any of clauses 11-17, wherein the first control unit is configured to receive a response message responsive to the execution of the datalink message, wherein the response message is configured to be one or more of displayed to the operator via a display device or audibly played as an audio file to the operator via an audio system.

Clause 19: the hands-free communication system of any of clauses 11-18, wherein the one or more sensors are configured to detect the one or more signals from the operator of an aircraft and the first control unit is configured to create the coded datalink message while the aircraft is one or more of on ground or in flight.

Clause 20: a non-transitory computer-readable storage medium comprising executable instructions that, in response to execution, cause one or more control units comprising one or more processors to perform the operations comprising:
detecting one or more signals from an operator, wherein the one or more signals that are detected are one or more of motion signals or audio signals;
creating one or more coded datalink messages by converting the one or more signals to one or more coded signals with a first control unit, wherein each of the one or more signals is associated with a corresponding coded signal based on a reference table;
communicating the one or more coded datalink messages with a second control unit;
decoding the one or more coded datalink messages by converting the one or more coded signals to the one or more signals with the second control unit based on the reference table; and
executing the datalink message with the second control unit by changing at least some data stored within a memory of the second control unit; and
displaying at least some of the data that is changed via a display device responsive to changing at least some of the data stored within the memory of the second control unit.

As described herein, examples of the present disclosure provide systems and methods for a hands-free communication system between systems onboard the aircraft and/or systems off-board the aircraft. The hands-free communication systems of the aircraft can allow a pilot to communicate directly with an operator off-board the aircraft, to update and/or enter information or data stored within one or more systems onboard the aircraft, or the like, without the pilot needing to physically engage with one or more knobs, switches, buttons, touchscreens, or the like, of the aircraft.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A method, comprising:
detecting one or more signals from an operator, wherein the one or more signals that are detected are one or more of motion signals or audio signals;
creating a coded datalink message by converting the one or more signals to one or more coded signals with a first control unit, wherein each of the one or more signals is associated with a corresponding coded signal based on a reference table;
communicating the coded datalink message with a second control unit;
decoding the coded datalink message by converting the one or more coded signals to the one or more signals with the second control unit based on the reference table; and
executing the datalink message with the second control unit.

2. The method of claim 1, wherein the first control unit is disposed onboard an aircraft and the second control unit is disposed onboard the aircraft.

3. The method of claim 1, wherein the first control unit is disposed off-board an aircraft and the second control unit is disposed onboard the aircraft.

4. The method of claim 1, wherein communicating the coded datalink message includes relaying the coded datalink message via one or more of an onboard relaying system or an off-board relaying system.

5. The method of claim 1, wherein executing the datalink message includes changing at least some data stored within a memory of the second control unit.

6. The method of claim 5, further comprising displaying at least some of the data that is changed via a display device responsive to changing at least some of the data stored within the memory of the second control unit.

7. The method of claim 5, further comprising:
creating an audio file associated with the at least some of the data that is changed with the second control unit; and
playing the audio file to the operator via an audio system.

8. The method of claim 1, further comprising controlling a display setting of a display device based at least in part on the one or more signals that are detected.

9. The method of claim 1, further comprising:
receiving a response message from the second control unit responsive to the execution of the datalink message by the second control unit; and
one or more of displaying the response message the operator via a display device or audibly playing an audio file of the response message to the operator via an audio system.

10. The method of claim 1, further comprising detecting the one or more signals from the operator of an aircraft and creating the coded datalink message while the aircraft is one or more of on ground or in flight.

11. A hands-free communication system, comprising:
one or more sensors configured to detect one or more signals from an operator, wherein the one or more signals that are detected are one or more of motion signals or audio signals;
a first control unit configured to create a coded datalink message by converting the one or more signals to one or more coded signals, wherein each of the one or more signals is associated with a corresponding coded signal based on a reference table; and
a second control unit configured to receive the coded datalink message from the first control unit, wherein the second control unit is configured to decode the coded datalink message by converting the one or more coded signals to the one or more signals with the second control unit based on the reference table,
wherein the second control unit is configured to execute the datalink message.

12. The hands-free communication system of claim 11, wherein the first control unit is disposed onboard an aircraft and the second control unit is disposed onboard the aircraft.

13. The hands-free communication system of claim 11, wherein the first control unit is disposed off-board an aircraft and the second control unit is disposed onboard the aircraft.

14. The hands-free communication system of claim 11, wherein the coded datalink message is configured to be communicated between the first control unit and the second control unit by relaying the coded datalink message via one or more of an onboard relaying system or an off-board relaying system.

15. The hands-free communication system of claim 11, wherein the second control unit is configured to execute the datalink message by changing at least some data stored within a memory of the second control unit.

16. The hands-free communication system of claim 15, further comprising a display device configured to display at least some of the data that is changed.

17. The hands-free communication system of claim 11, further comprising a display device, wherein the one or more signals that are detected are configured to change a display setting of the display device.

18. The hands-free communication system of claim 11, wherein the first control unit is configured to receive a response message responsive to the execution of the datalink message, wherein the response message is configured to be one or more of displayed to the operator via a display device or audibly played as an audio file to the operator via an audio system.

19. The hands-free communication system of claim 11, wherein the one or more sensors are configured to detect the one or more signals from the operator of an aircraft and the first control unit is configured to create the coded datalink message while the aircraft is one or more of on ground or in flight.

20. A non-transitory computer-readable storage medium comprising executable instructions that, in response to execution, cause one or more control units comprising one or more processors to perform the operations comprising:
detecting one or more signals from an operator, wherein the one or more signals that are detected are one or more of motion signals or audio signals;
creating one or more coded datalink messages by converting the one or more signals to one or more coded signals with a first control unit, wherein each of the one or more signals is associated with a corresponding coded signal based on a reference table;
communicating the one or more coded datalink messages with a second control unit;
decoding the one or more coded datalink messages by converting the one or more coded signals to the one or more signals with the second control unit based on the reference table;
executing the datalink message with the second control unit by changing at least some data stored within a memory of the second control unit; and
displaying at least some of the data that is changed via a display device responsive to changing at least some of the data stored within the memory of the second control unit.
